(19) United States
(12) Patent Application Publication
(10) Pub. No.: US 2025/0193238 A1
(43) Pub. Date: Jun. 12, 2025

(54) INFORMATION PROCESSING APPARATUS, PHISHING SITE DETECTION METHOD, AND PROGRAM THEREOF

(71) Applicant: NEC Corporation, Minato-ku, Tokyo (JP)

(72) Inventors: Senju YAMAZAKI, Tokyo (JP); Kentaro SONODA, Tokyo (JP); Kohei MATSUMOTO, Tokyo (JP); Ryutaro SAKAKI, Tokyo (JP)

(73) Assignee: NEC Corporation, Minato-ku, Tokyo (JP)

(21) Appl. No.: 18/845,011

(22) PCT Filed: Mar. 16, 2022
(86) PCT No.: PCT/JP2022/011829

§ 371 Date: Sep. 9, 2024

(51) Int. Cl. H04L 9/40; G06V 30/19

(52) U.S. Cl. CPC H04L 63/1483; G06V 30/19093

(57) ABSTRACT

An information processing apparatus, comprising: an information acquisition part configured to acquire suspicious site information; an element extraction part configured to extract a specified element(s) from the suspicious site information; and a similarity determination part configured to calculate a similarity of character strings between a specified domain of a URL in the specified element(s) and a specified domain of a URL of the suspicious site information, or a similarity of between all or any of the specified element(s) to determine whether or not a site related to the suspicious site information is the phishing site based on whether or not the similarity is within a predetermined numerical range.

### FIELD

The present invention relates to an information processing apparatus, a phishing site detection method, and a program thereof.

### BACKGROUND

Recently, phishing sites (fake sites) that resemble legitimate web pages or domains have become more sophisticated, and it has become difficult to distinguish or determine whether or not they are genuine. Criminals attempt to steal personal information such as authentication information and credit card information through phishing sites. In particular, phishing sites that resemble websites operated by legitimate companies pose a problem in that the existence of such phishing sites increases the reputation risk of legitimate companies. Therefore, in order to take down and eradicate such phishing sites, a mechanism is needed that can search for and find phishing sites on the Internet.

As a mechanism for searching for and finding phishing sites, for example, there is a method for determining whether or not a site to be inspected (suspicious phishing site) is a phishing site by using the similarity acquired by comparing information related to preregistered legitimate sites (for example, feature vectors, CSS (Cascading Style Sheets), logo images, etc.) with information related to the site to be inspected (suspicious phishing site) (refer to Patent Literature (PTL) 1 and Non-PTLs 1 and 2, for example).

### CITATION LIST

### Patent Literature

PTL 1: WO2020/044469 A

### Non-Patent Literature

Non-PTL 1: J. Mao, W. Tian, P. Li, T. Wei and Z. Liang, “Phishing-Alarm: Robust and Efficient Phishing Detection via Page Component Similarity”, in IEEE Access, vol. 5, pp. 17020-17030, 2017.
Non-PTL 2: O. Asudeh and M. Wright, POSTER: Phishing Website Detection with a Multiphase Framework to Find Visual Similarity. In Proceedings of the 2016 ACM SIGSAC Conference on Computer and Communications Security (CCS '16). ACM, New York, NY, USA, 1790-1792. 2016.

### SUMMARY

### Technical Problem

The following analysis is provided by the present inventors.

However, the methods disclosed in Patent Literature 1 and Non-Patent Literatures 1 and 2 require information relating to legitimate sites to be prepared or defined in advance, and therefore they cannot be said to be efficient methods for finding phishing sites that are proliferating indiscriminately on the Internet.

It is a main object of the present invention to provide an information processing apparatus, a phishing site detection method, and a program thereof that can contribute to efficiently finding phishing sites without preparing information related to legitimate sites in advance.

### Solution to Problem

An information processing apparatus relating to a first aspect, comprising:
an information acquisition part configured to acquire suspicious site information;
an element extraction part configured to extract a specified element(s) from the suspicious site information; and
a similarity determination part configured to calculate a similarity of character string between a specified domain of a URL in the specified element(s) and a specified domain of a URL of the suspicious site information, or a similarity of between all or any of the specified element(s) to determine whether or not a site related to the suspicious site information is a phishing site based on whether or not the similarity is within a predetermined numerical range.

A phishing site detection method relating to a second aspect is a phishing site detection method that detects a phishing site using hardware resources, comprising steps of:
acquiring suspicious site information;
extracting specified element(s) from the suspicious site information; calculating a similarity of character strings between a specified domain of a URL in the specified element(s) and a specified domain of a URL of the suspicious site information, or a similarity of character strings between all or any of the specified element(s); and
determining whether or not the site related to the suspicious site information is the phishing site based on whether or not the similarity is within a predetermined numerical range.

A program relating to a third aspect is a program causing hardware resources to execute process of detecting the phishing site, comprising processes of:
acquiring suspicious site information;
extracting specified element(s) from the suspicious site information; calculating a similarity of character strings between a specified domain of a URL in the specified element(s) and a specified domain of a URL of the suspicious site information, or a similarity of character strings between all or any of the specified element(s); and
determining whether or not the site related to the suspicious site information is the phishing site based on whether or not the similarity is within a predetermined numerical range.

The program can be recorded on a computer readable storage medium. The storage medium can be a non-transitory medium such as a semiconductor memory, a hard disk, a magnetic recording medium, and/or an optical recording medium, etc. The present disclosure can also be embodied as a computer program product. The program is input to the computer apparatus from an input apparatus or an external apparatus via a communication interface, stored in a storage apparatus, and drives the processor according to a predetermined step or process. If necessary, the processing result, including an intermediate state, can be displayed on a display device for each step, and/or the computer apparatus can communicate with the outside via the communication interface. As an example, a computer apparatus for this purpose typically includes a processor, a storage apparatus, an input apparatus, a communication interface, and a display device connectable to each other via a bus.

### Advantageous Effect of Invention

The first to third aspects described above can contribute to efficiently finding phishing sites without preparing information on legitimate sites in advance.

([Translation Note]“element(s)” and like refer to “at least one element” and like.)

### BRIEF DESCRIPTION OF DRAWINGS

FIG. 1 is a block diagram showing a schematic configuration of an information processing apparatus according to a first example embodiment.

FIG. 2 is an image diagram schematically showing an example of a phishing site login screen of a suspicious site where a phishing site detection process is performed in the information processing apparatus according to the first example embodiment.

FIG. 3 is an image diagram showing an example of an operation of an element determination part in the information processing apparatus according to the first example embodiment.

FIG. 4 is an image diagram showing an example of an operation of a domain similarity determination part in the information processing apparatus according to the first example embodiment.

FIG. 5 is a flowchart schematically showing an example of an operation of a phishing site detection part of the information processing apparatus according to the first example embodiment.

FIG. 6 is a block diagram showing a schematic configuration of an information processing apparatus according to a second example embodiment.

FIG. 7 is a block diagram showing a schematic configuration of an information processing apparatus according to a second example embodiment.

FIG. 8 is an image diagram schematically showing an example of an operation of an element similarity determination part in the information processing apparatus according to the second example embodiment.

FIG. 9 is a flowchart schematically showing an operation of an information processing apparatus according to a second example embodiment.

FIGS. 10A-10D are transition diagrams schematically showing the operation of the information processing apparatus according to the second example embodiment in the case of a suspicious mail.

FIG. 11 is a block diagram showing a schematic configuration of an information processing apparatus according to a third example embodiment.

FIG. 12 is a block diagram showing a schematic configuration of hardware resources.

### DETAILED DESCRIPTION

Hereinafter, the detailed description will be made with reference to the drawings. In addition, when drawing reference symbols are used in this application, they are merely intended to aid understanding and are not intended to limit the present invention to the illustrated modes. In addition, the following example embodiments are merely examples and do not limit the present invention. In addition, the connection lines between blocks in the drawings and the like referred to in the following description include both bidirectional and unidirectional. One way arrows are used to schematically indicate a flow of a main signal (data) and do not exclude bidirectionality. Furthermore, although not explicitly shown in the circuit diagrams, block diagrams, internal configuration diagrams, connection diagrams, and the like shown in the present disclosure, input port or output port exists at each of the input or output ends of connection lines. The same is true for input/output interfaces. A program is executed via a computer apparatus, which includes, for example, a processor, a storage device, an input device, a communication interface, and a display device as necessary, and the computer apparatus is configured to be able to communicate with apparatus (including computers) inside or outside the apparatus via the communication interface, regardless of whether it is wired or wireless.

### Example Embodiment 1

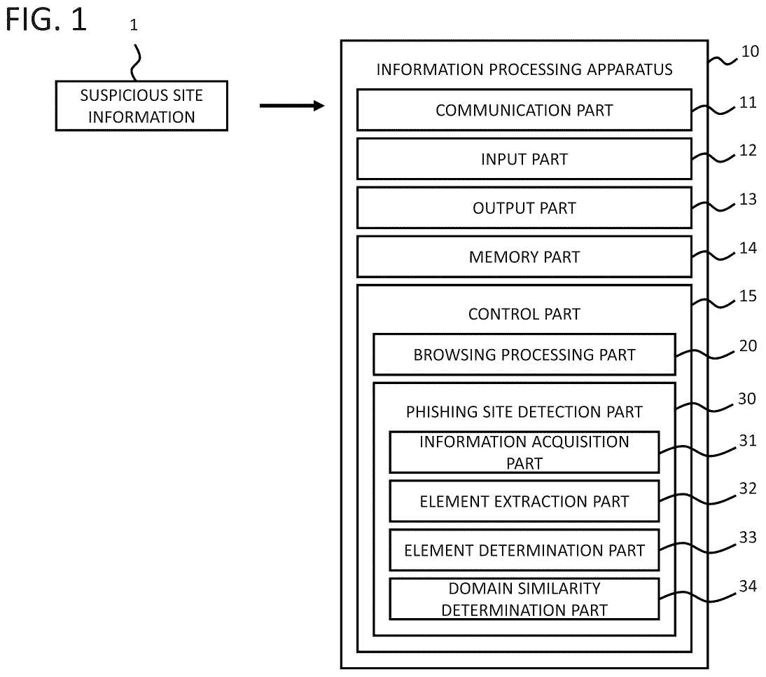

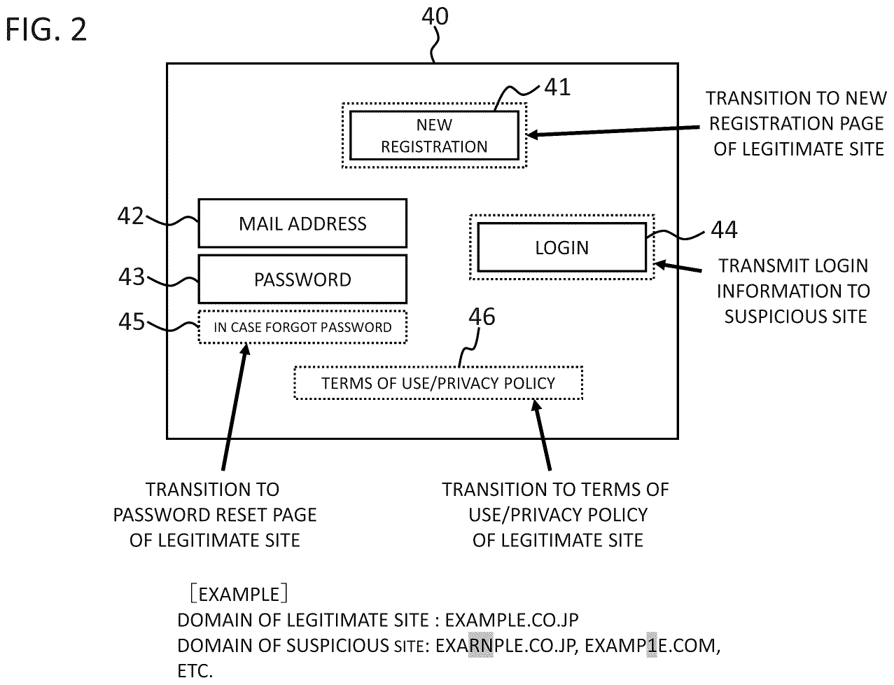

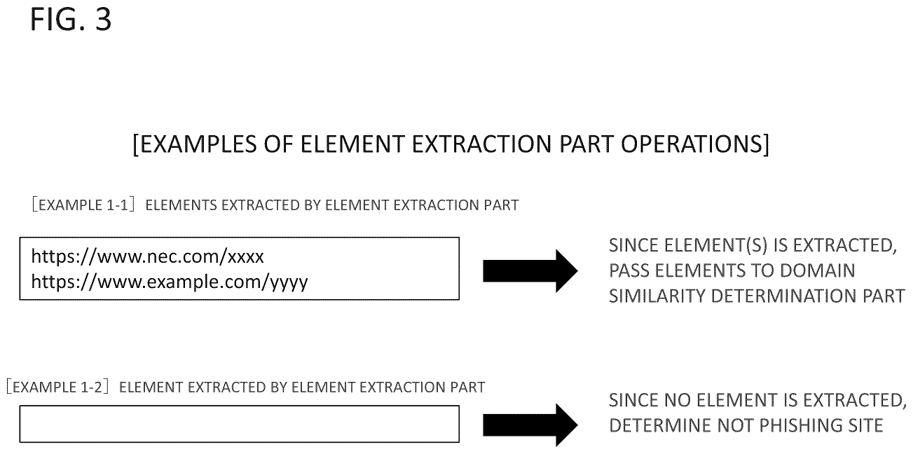

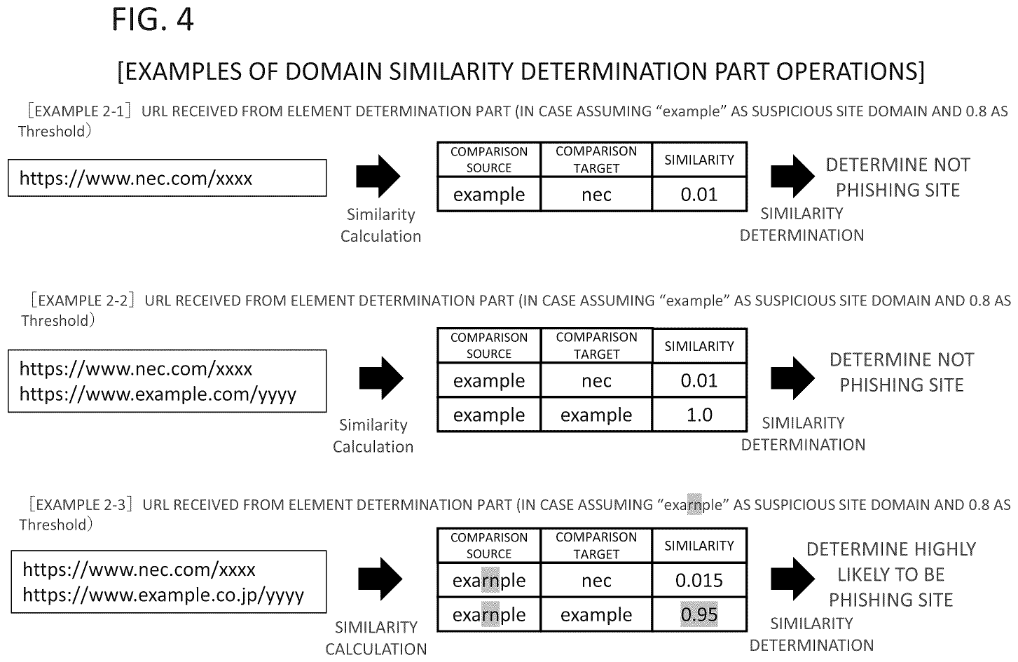

A description will be made regarding the information processing apparatus according to an example embodiment 1 with reference to the drawings. FIG. 1 is a block diagram showing a schematic configuration of an information processing apparatus according to a first example embodiment. FIG. 2 is an image diagram schematically showing an example of a phishing site login screen of a suspicious site where a phishing site detection process is performed in the information processing apparatus according to the first example embodiment. FIG. 3 is an image diagram showing an example of an operation of an element determination part in the information processing apparatus according to the first example embodiment. FIG. 4 is an image diagram showing an example of an operation of a domain similarity determination part in the information processing apparatus according to the first example embodiment.

An information processing apparatus 10 is an apparatus that processes information (refer to FIG. 1). The information processing apparatus 10 may be, for example, a personal computer, a tablet terminal, a smartphone, etc. The information processing apparatus 10 may communicate with a server apparatus (not shown) via a network (not shown), and may transmit information to the server apparatus to acquire site information (legitimate site information, suspicious site information, fraudulent site information, etc.) provided by the server apparatus. The information processing apparatus 10 has a function to display the acquired site information. The information processing apparatus 10 has a function to transmit information entered in an input field for the acquired site information to a linked server apparatus. The information processing apparatus 10 has a function to display site information (site information provided by a server apparatus) of a URL (Uniform Resource Locator) of the hyperlink destination by operating (for example, clicking, tapping, etc.) a hyperlink in the acquired site information. The information processing apparatus 10 has a function to detect whether or not the acquired site information (a site related to the suspicious site information 1) is a phishing site (a fake site that resembles legitimate site information or a domain). The information processing apparatus 10 includes a communication part 11, an input part 12, an output part 13, a storage part 14, and a control part 15.

Here, a suspicious site information 1 may be acquired from a server apparatus (not shown) via a network (not shown). The suspicious site information 1 may also be information acquired by accessing a hyperlink in the phishing mail (or “email”; not shown). As shown in FIG. 2, for example, the suspicious site information 1 may include a new registration button 41 that transitions to a new registration page of a legitimate site, a mail address input field 42, a password input field 43, a login button 44 that transmits login information (mail address and password in this case) to the suspicious site, a forgot password button 45 that transitions to a password reset page of the legitimate site, and a terms of use/privacy policy button 46 that transitions to a terms of use/privacy policy page of the legitimate site.

The communication part 11 is a functional part that communicates information (wired communication or wireless communication) (refer to FIG. 1). The communication part 11 is communicatively connected to a network (not shown). The communication part 11 communicates under control of the control part 15. The communication part 11 may receive the suspicious site information 1. The communication part 11 may transmit information entered in an input field of the suspicious site information 1 to a linked server apparatus. The communication part 11 may access a hyperlink destination in the suspicious site information 1 to receive information on the URL of the hyperlink destination.

The input part 12 is a functional part that inputs information (character input, voice input, operation input, etc.) (refer to FIG. 1). The input part 12 performs input under control of the control part 15. For example, a touch panel, a mouse, a keyboard, a microphone, a gesture sensor, etc. may be used as the input part 12.

The output part 13 is a functional part that outputs information (display output, audio output, etc.) (refer to FIG. 1). The output part 13 performs output under control of the control part 15. For example, a display, a speaker, etc. may be used as the output part 13.

The storage part 14 is a functional part that stores information (including data and program(s)) (refer to FIG. 1). The storage part 14 stores information under control of the control part 15.

The control part 15 is a functional part that controls the communication part 11, the input part 12, the output part 13, and the storage part 14 (refer to FIG. 1). For example, a processor such as a CPU (Central Processing Unit) or an MPU (Micro Processor Unit) may be used as the control part 15. The control part 15 may perform specified information processing described in a program(s) by executing a specified program(s) stored in the storage part 14. The control part 15 comprises a browsing processing part 20 and a phishing site detection part 30.

The browsing processing part 20 is a functional part that performs various processes related to browsing of site information (such as transmission and reception, browsing, input and output) (refer to FIG. 1). For example, the browsing processing part 20 may be one that is executed by a browser software. The phishing site detection part 30 is plugged into the browsing processing part 20.

The phishing site detection part 30 is a functional part that detects whether or not the suspicious site information 1 being viewed is information related to the phishing site (refer to FIG. 1). The phishing site detection part 30 is a part configured to be capable of determining whether or not a suspicious site is the phishing site by extracting a specified element(s) (here, a specified domain in the URL (a unique part (a part having distinguishability) in the entire domain)) in the suspicious site information 1 against a homograph attack that deceives the user's vision, and determining the similarity. The phishing site detection part 30 may be one that is realized by executing a specified program(s), tool(s), script(s), shell(s), command(s), etc. The phishing site detection part 30 may be plugged into the browsing processing part 20. The phishing site detection part 30 includes an information acquisition part 31, an element extraction part 32, an element determination part 33, and a domain similarity determination part 34.

Here, it is assumed as premise of the phishing site, that criminals who use the phishing site do not prepare their own content that is not directly related to achieving their goal, but use content from legitimate sites. This is because criminals' goal is to steal authentication information, credit card information, etc., and preparing content that is not directly related to achieving this goal takes resources and effort. In addition, it is assumed that phishing sites have character strings that are similar to the domain of legitimate sites. This is a technique used by criminals to prevent targets from determining that the site is the phishing site due to the URL character string.

The information acquisition part 31 is a functional part that acquires the suspicious site information 1 (for example, the content (HTML information) of the website) being browsed by the browsing processing part 20 (refer to FIG. 1). The information acquisition part 31 passes the acquired suspicious site information 1 to the element extraction part 32.

The element extraction part 32 is a functional part that extracts a specified element(s) (here, a link element(s) in the suspicious site information 1) from the suspicious site information 1 acquired by the information acquisition part 31 (refer to FIG. 1). As a method for extracting a specified element(s), for example, a link element(s) is extracted as a specified element(s) from the suspicious site information 1 (HTML information) using an HTML tag as a clue (for example, a character string starting with http(s), link rel, Img src, href, background-image:url, etc.). Here, the link element(s) does not include the URL of the suspicious site information 1 itself, which is not set as a link destination. The element extraction part 32 passes the extracted specified element(s) to the element determination part 33.

The element determination part 33 is a functional part that determines whether or not a URL exists in a specified element(s) extracted by the element extraction part 32 (refer to FIG. 1). When a URL exists in a specified element(s) extracted by the element extraction part 32, the element determination part 33 passes the URL to the domain similarity determination part 34. When a URL does not exist in a specified element(s) extracted by the element extraction part 32, the element determination part 33 determines that the site related to the suspicious site information 1 is not the phishing site. For example, as in example 1-1 of FIG. 3, when the specified element(s) extracted by the element extraction part 32 are “https://www.nec.com/xxxx” and “https://www.example.com/yyyy”, a URL exists, so the URL is passed to the domain similarity determination part 34. When there is no specified element(s) extracted by the element extraction part 32 as in example 1-2 of FIG. 3, there is no URL, so it is determined that the site related to the suspicious site information 1 is not the phishing site.

The domain similarity determination part 34 is a functional part that calculates the similarity of the character string between a specified domain of the URL (the URL of the link destination in the suspicious site information 1) from the element determination part 33 and a specified domain of the URL of the suspicious site information 1 itself to determine whether or not the site related to the suspicious site information 1 is the phishing site based on whether or not the similarity is within a predetermined numerical range (refer to FIG. 1). From the URL (the URL of the link destination in the suspicious site information 1) from the element determination part 33, the domain similarity determination part 34 extracts the scheme (http://), host (www), top level domain (com, jp, etc.), second level domain (co, ac, go, etc.) representing the organizational attribute when there is an organizational attribute, and a specified domain excluding the directory (for example, a third level domain, a second level domain that does not represent the attribute of the organization, etc.). The domain similarity determination part 34 acquires the URL of the suspicious site information 1 itself from the information acquisition part 31 to extract from the acquired URL a specified domain (for example, a third level domain, a second level domain that does not represent an organizational attribute, etc.) excluding the scheme (http://), host (www), top level domain (generic top level domains (gTLDs) such as .com, .net, .org, etc., and country code top level domains (ccTLDs) such as .jp, .uk, .fr), and second level domain (co, ac, go, etc.) representing the organizational attribute when there is an organizational attribute. Note that the extracted specified domain may include a subdomain(s) when the URL includes a subdomain(s). The domain similarity determination part 34 calculates a similarity X of the character string between the specified domain of the URL of the link destination in the extracted suspicious site information 1 and the specified domain of the URL of the extracted suspicious site information 1 itself. The method for calculating the similarity of character strings may be, for example, a Gestalt pattern matching method, a Levenshtein distance method, a Jaro-Winkler distance method, an image comparison method, etc., and any method may be used. The similarity X has a value between 0 and 1, where 1 indicates the same and 0 indicates dissimilar. The domain similarity determination part 34 determines whether or not the calculated similarity X is equal to or greater than a threshold and less than 1. The threshold is a predetermined value. When there are a plurality of calculated similarities, it is determined whether or not each similarity is equal to or greater than a threshold and less than 1. When the similarity X is equal to or greater than a threshold and less than 1 (when there are a plurality of similarities, at least one similarity is equal to or greater than a threshold and less than 1), the domain similarity determination part 34 determines that the site related to the suspicious site information 1 is highly likely to be a phishing site to cause the output part 13 to output a warning indicating that the site related to the suspicious site information 1 is highly likely to be the phishing site. The warning may be output by any output method, such as a popup display, a voice output, etc. When the similarity X is equal to or greater than the threshold and is not less than 1 (when the similarity X is less than the threshold or 1, or when there are multiple similarities, all of them are less than the threshold or 1), the domain similarity determination part 34 determines that the site related to the suspicious site information 1 is not the phishing site.

As an example of an operation of the domain similarity determination part 34, for example, as in example 2-1 of FIG. 4, when the URL received from the element determination part 33 is “https://www.nec.com/xxxx”, the domain of the suspicious site is “example.co.jp”, and the threshold is 0.8, the specified domain of the suspicious site that is the source of comparison will be “example”, the specified domain of the link destination of the suspicious site that is the target of comparison will be “nec”, and the similarity between the source of comparison and the target of comparison will be calculated to be, for example, 0.01 (depending on the calculation method), and since the similarity of 0.01 is not greater than or equal to the threshold 0.8 and less than 1, the suspicious site is determined not to be the phishing site.

Further, for example, as in example 2-2 in FIG. 4, when the URLs received by the domain similarity determination part 34 from the element determination part 33 are “https://www.nec.com/xxxx” and “https://www.example.com/yyyy”, the domain of the suspicious site is “example.co.jp”, and the threshold is 0.8, the specified domain of the suspicious site that is the source of comparison is “example”, and the specified domains of the link destinations of the suspicious site that is the target of comparison are “nec” and “example”, and the similarity between the source of comparison and the target of comparison are calculated, for example, to be 0.01 and 1.0 (depending on the calculation method), since both of similarities 0.01 and 1.0 are not greater than the threshold 0.8 and are not less than 1, so it is determined that the suspicious site is not the phishing site.

Furthermore, for example, as in example 2-3 in FIG. 4, when the URLs received by the domain similarity determination part 34 from the element determination part 33 are “https://www.nec.com/xxxx” and “https://www.example.co.jp/yyyy,” the domain of the suspicious site is “example.co.jp,” and the threshold is 0.8, the specified domain of the suspicious site that is the source of comparison is “example”, the specified domains of the link destinations of the suspicious site that is the target of comparison are “nec” and “example,” and the similarity between the source of comparison and the target of comparison is calculated to be, for example, 0.015 and 0.95 (depending on the calculation method), although the similarity 0.015 is not greater than or equal to the threshold 0.8 and not less than 1, the similarity 0.95 is greater than or equal to the threshold 0.8 and less than 1, and therefore the suspicious site is determined to be highly likely to be the phishing site.

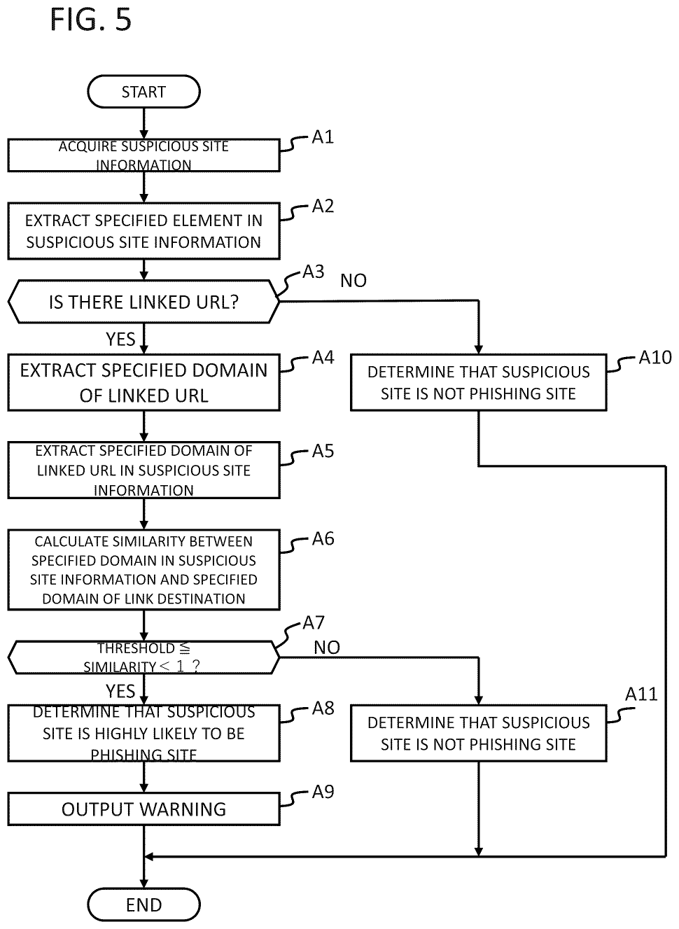

A description will be made with reference to the drawings regarding the operation of the information processing apparatus according to the first example embodiment. FIG. 5 is a flowchart schematically showing an example of an operation of the phishing site detection part of the information processing apparatus according to the first example embodiment. Note that FIG. 1 should be referred to regarding the configuration of the information processing apparatus.

First, the information acquisition part 31 of the phishing site detection part 30 of the information processing apparatus 10 acquires suspicious site information 1 being browsed by the browsing processing part 20 (step A1).

Next, the element extraction part 32 of the phishing site detection part 30 extracts a specified element(s) (here, the URL of the link destination in the suspicious site information 1) from the suspicious site information 1 acquired by the information acquisition part 31 (step A2).

Next, the element determination part 33 of the phishing site detection part 30 determines whether or not a URL of a linked destination exists in the specified element(s) extracted by the element extraction part 32 (step A3). When a URL of a linked destination does not exist (NO in step A3), the process proceeds to step A10.

When a linked URL exists (YES in step A3), the domain similarity determination part 34 of the phishing site detection part 30 extracts the scheme (http://), host (www), top level domain (com, jp, etc.), second level domain (co, ac, go, etc.) representing the organizational attribute when there is an organizational attribute, and a specified domain excluding directories (for example, third level domain, second level domain not representing organizational attributes, etc.) from linked URL (linked URL in the suspicious site information 1) determined by the element determination part 33 (step A4).

Next, the domain similarity determination part 34 acquires the URL of the suspicious site information 1 itself from the information acquisition part 31 to extract, from the acquired URL, specified domains (for example, third level domains, second level domains that do not represent organizational attributes, etc.) excluding the scheme (http://), host (www), top level domain (com, jp, etc.), second level domain (co, ac, go, etc.) representing the organizational attribute when there is an organizational attribute, (step A5).

Next, the domain similarity determination part 34 calculates a similarity X between a specified domain of the linked URL in the extracted suspicious site information 1 and a specified domain of the URL of the extracted suspicious site information 1 itself (step A6).

Next, the domain similarity determination part 34 determines whether or not the calculated similarity X is equal to or greater than the threshold and less than 1 (step A7). When the similarity X is not equal to or greater than the threshold and less than 1 (NO in step A7), the process proceeds to step A11.

When the similarity X is equal to or greater than the threshold and less than 1 (YES in step A7), the domain similarity determination part 34 determines that the site related to the suspicious site information 1 is highly likely to be the phishing site (step A8).

Next, the domain similarity determination part 34 outputs a warning indicating that the site related to the suspicious site information is highly like to be the phishing site (step A9) from the output part 13, and then ends the process.

When the linked URL does not exist (NO in step A3), the element determination part 33 determines that the site related to the suspicious site information 1 is not the phishing site (step A10), and then ends the process.

When the similarity X is not equal to or greater than the threshold value and less than 1 (NO in step A7), the domain similarity determination part 34 determines that the site related to the suspicious site information 1 is not the phishing site (step A11), and then ends the process.

According to the first example embodiment, since whether or not a site related to the suspicious site information 1 is the phishing site is determined based on the similarity of character strings between a specified domain in the URL of the suspicious site information 1 itself and a specified domain in the URL of a link destination in the suspicious site information 1, it is possible to contribute efficiently to find the phishing sites without preparing information related to legitimate sites in advance. That is, phishing sites on the Internet may be found without collecting or defining legitimate sites in advance.

### Example Embodiment 2

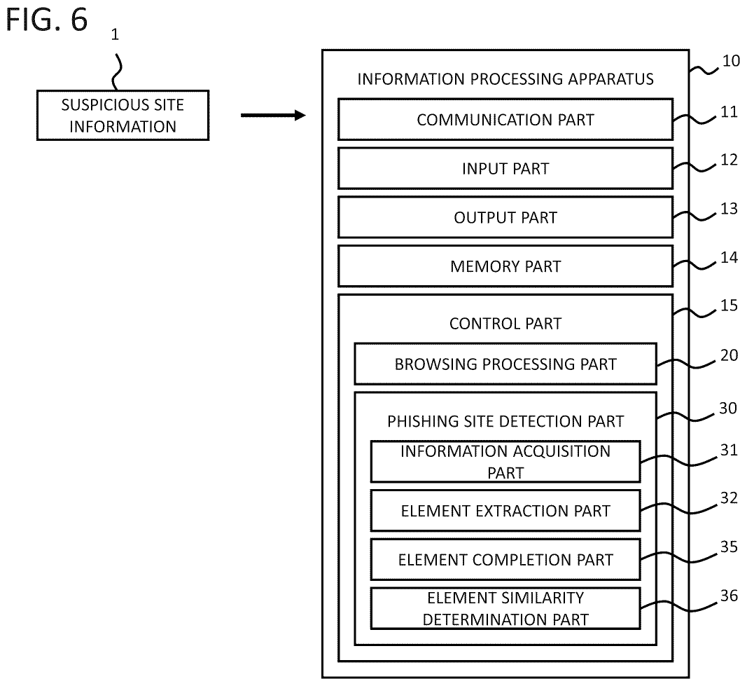

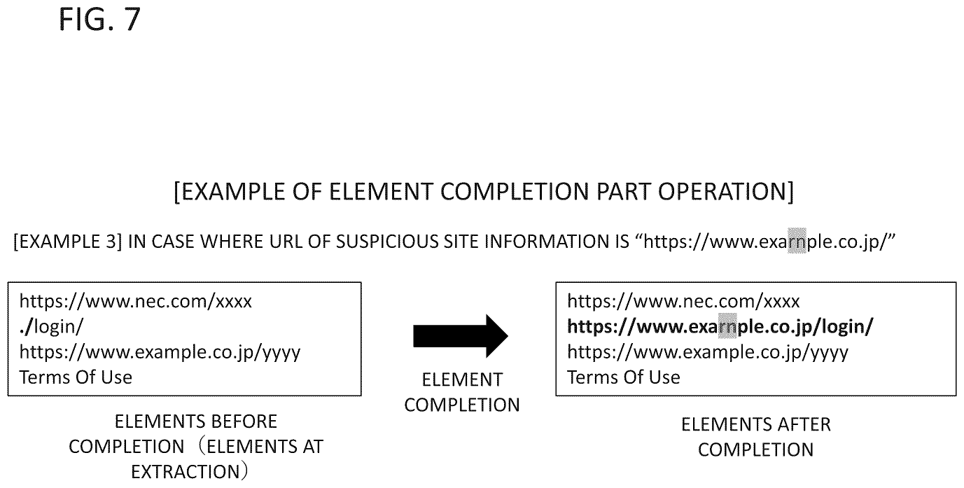

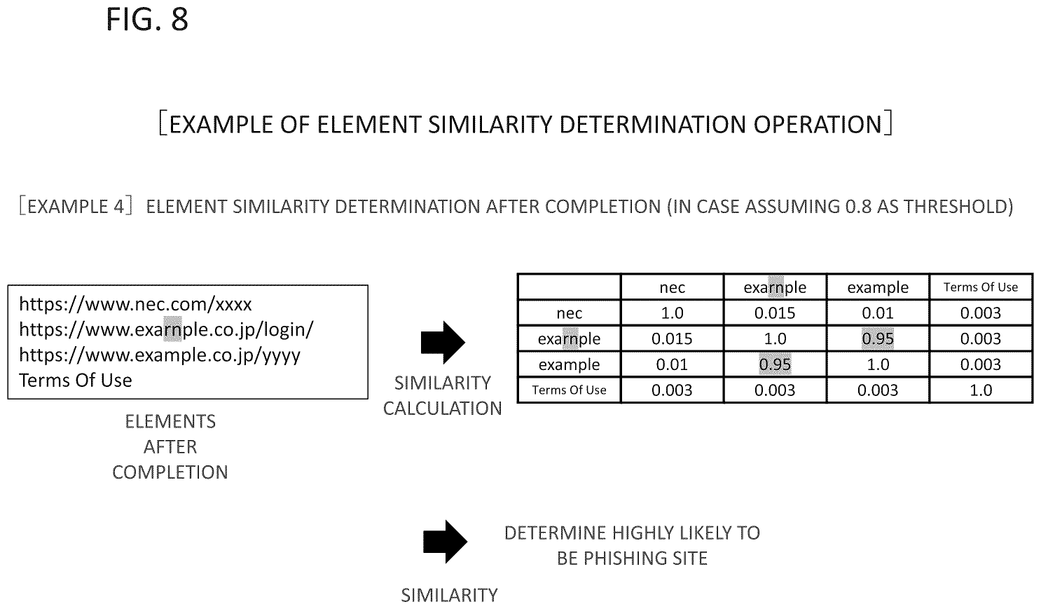

A description will be made with reference to the drawings regarding an information processing apparatus according to an example embodiment 2. FIG. 6 is a block diagram showing a schematic configuration of an information processing apparatus according to a second example embodiment. FIG. 7 is a block diagram showing a schematic configuration of an information processing apparatus according to a second example embodiment. FIG. 8 is an image diagram schematically showing an example of an operation of an element(s) similarity determination part in the information processing apparatus according to the second example embodiment.

The second example embodiment is a modification of the first example embodiment, and determines whether or not the site related to the suspicious site information 1 is the phishing site based on the similarity of character strings between all (a part of them is acceptable) element(s) extracted from the suspicious site information 1. Also, when a relative path(s) describing a relative positional relationship from a current location (directory) exists in the suspicious site information 1, the URL is complemented to determine whether or not the site related to the suspicious site information 1 is the phishing site. The information processing apparatus 10 according to the second example embodiment is similar to the information processing apparatus (10 in FIG. 1) according to the first example embodiment in terms of the communication part 11, input part 12, output part 13, and storage part 14, and similar to the browsing processing part 20 of the control part 15, but differs in the way how information is processed by the phishing site detection part 30 of the control part 15 (refer to FIG. 6).

The phishing site detection part 30 comprises an information acquisition part 31, an element extraction part 32, an element completion part 35, and an element similarity determination part 36. Note that the information acquisition part 31 is the same as the information acquisition part (31 in FIG. 1) of the first example embodiment.

The element extraction part 32 is a functional part that extracts specified element(s) (here, link element(s), relative path(s), and other character strings in the suspicious site information 1) from the suspicious site information 1 acquired by the information acquisition part 31 (refer to FIG. 6). As a method for extracting the URL of the link destination in the suspicious site information 1, for example, the linked URL is extracted as a specified element(s) from the suspicious site information 1 (HTML information) using HTML tags (for example, character strings starting with http(s), link rel, Img src, href, background-image:url, etc.). Here, the linked URL does not include the URL of the suspicious site information 1 itself, which is not set as the link destination. As a method for extracting the relative path(s), for example, the relative path(s) can be extracted using “./” as a clue, but any method may be used. Furthermore, as another character string, for example, a keyword can be used. The element extraction part 32 passes the extracted specified element(s) to the element completion part 35. When the element extraction part 32 is unable to extract a specified element(s), it may be determined that the site related to the suspicious site information 1 is not the phishing site to terminate the process.

The element completion part 35 is a functional part that completes a relative path(s) so that it becomes a URL when the specified element(s) extracted by the element extraction part 32 has a relative path(s) (refer to FIG. 6). The element completion part 35 determines whether or not the specified element(s) received from the element extraction part 32 has a relative path(s). Whether or not a relative path(s) exists may be determined by any method, such as using “./” as a clue. The element completion part 35 completes the relative path(s) so that it becomes a URL when the specified element(s) extracted by the element extraction part 32 has the relative path(s). As a completion method, the element completion part 35 acquires the URL of the suspicious site information 1 from the information acquisition part 31, and converts the “./” part of the relative path(s) to the acquired URL. For example, when the URL of suspicious site information 1 is “https://www.example.co.jp/” as in example 3 in FIG. 7, the relative path(s) “./login/” of the element(s) (element(s) before completion) at the time of extraction by element extraction part 32 is complemented so as to be “https://www.example.co.jp/login/” so that it becomes a URL. The element completion part 35 passes the URL with the relative path(s) complemented to the element similarity determination part 36 as a specified element(s). The element completion part 35 also passes specified element(s) other than the relative path(s) as they are to the element similarity determination part 36. When the specified element(s) extracted by element extraction part 32 does not have a relative path, the element completion part 35 skips it and passes all of the specified elements as they are to the element similarity determination part 36.

The element similarity determination part 36 is a functional part that calculates the similarity of character strings between all (a part of them is acceptable) of the specified element(s) acquired from the element completion part 35 to determine whether or not the site related to the suspicious site information 1 is the phishing site (refer to FIG. 6). The element similarity determination part 36 searches for a URL in the specified element(s) acquired from the element completion part 35, and when a URL is found, extracts the scheme (http://), host (www), top level domain (com, jp, etc.), second level domain (co, ac, go, etc.) representing the organizational attribute when there is an organizational attribute, and a specified domain excluding a directory (for example, a third level domain, a second level domain that does not represent the attribute of an organization, etc.) from the URL (the URL of the link destination in the suspicious site information 1) as specified element(s). Note that the extracted specified domain may include a subdomain(s) when a subdomain(s) is included in the URL. The element similarity determination part 36 calculates a similarity X of character strings between all (a part of them is acceptable) of the specified element(s). The method of calculating the similarity of character strings may be, for example, a Gestalt pattern matching method, a Levenshtein distance method, a Jaro-Winkler distance method, an image comparison method, etc., and any method may be used. The similarity X has a value between 0 and 1, where 1 indicates the same, and 0 indicates dissimilar. The element similarity determination part 36 determines whether or not there is at least one similarity among the calculated similarities that is equal to or greater than a threshold and less than 1. The threshold is a predetermined value. When there is at least one similarity that is equal to or greater than the threshold and less than 1, the element similarity determination part 36 determines that the site related to the suspicious site information 1 is highly likely to be the phishing site, and outputs a warning indicating that the site related to the suspicious site information 1 is highly likely to be the phishing site from the output part 13. The warning may be output in any manner, such as a popup display or a voice output. When there is no similarity that is equal to or greater than the threshold and less than 1, the element similarity determination part 36 determines that the site related to the suspicious site information 1 is not the phishing site. Note that, when calculating the similarity of character strings between some specified element(s), element(s) that clearly do not include a domain (for example, keywords such as a part of “terms of use”) may be excluded and the similarity of character strings between the remaining specified element(s) may be calculated.

As an example of the operation of the element similarity determination part 36, for example, when the element(s) completed by the element completion part 35 are “https://www.nec.com/xxxx,” “https://www.example.co.jp/login/,” “https://www.example.co.jp/yyyy,” and “Terms of Use,” as shown in example 4 of FIG. 8, and the threshold is 0.8, the element similarity determination part 36 converts the URL to a specified domain and calculates the similarity, which results in the table of FIG. 8. Since there are two similarities that are greater than the threshold 0.8 and less than 1 (a similarity between a combination of “example” and “example,” and a similarity between a combination of “example” and “example”), the element similarity determination part 36 determines that the site related to the suspicious site information 1 is highly likely to be the phishing site.

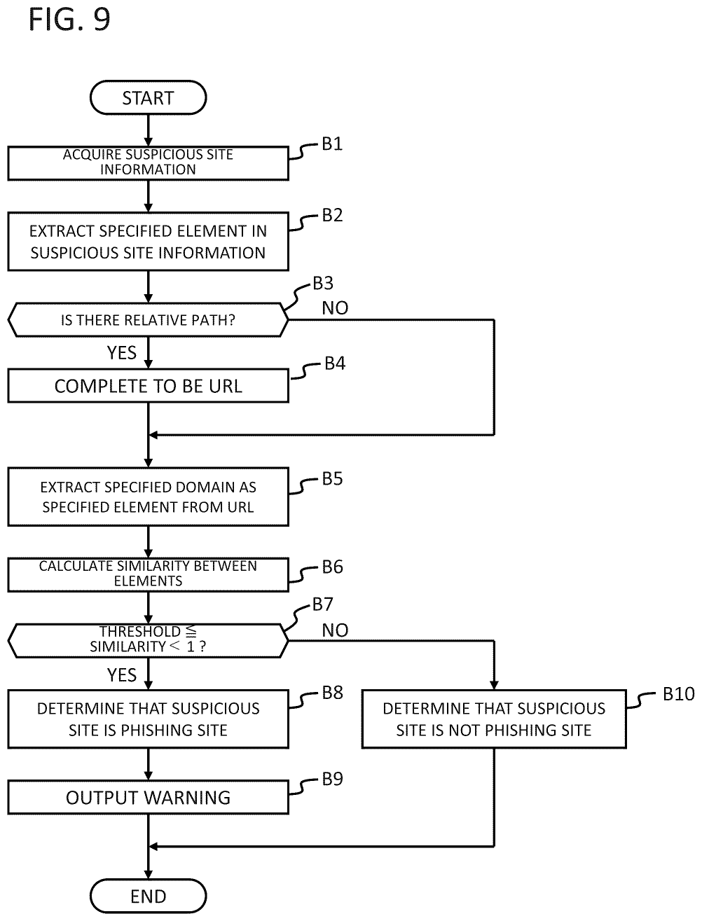

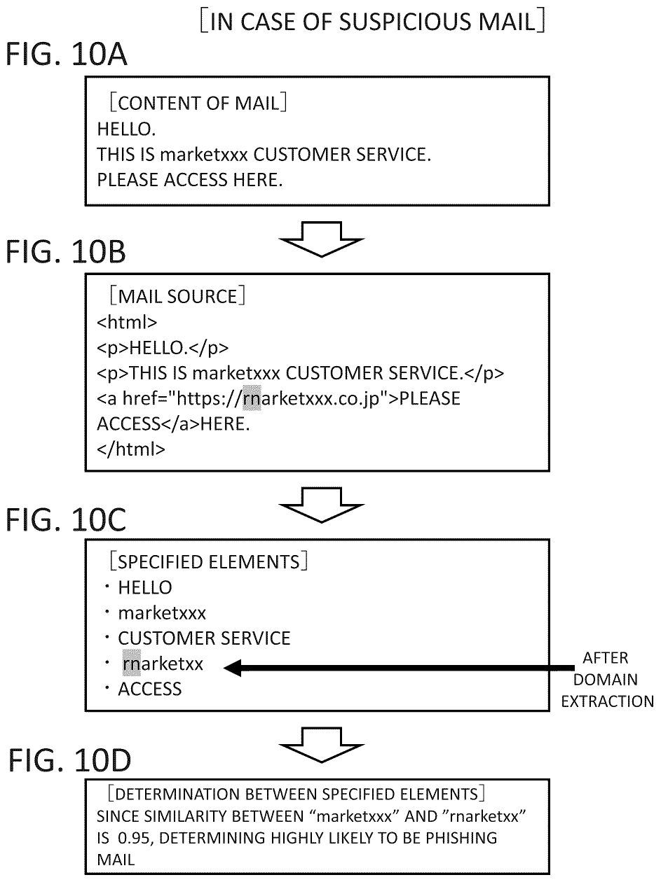

A description will be made with reference to the drawings regarding an operation of the information processing apparatus according to the second example embodiment. FIG. 9 is a flowchart schematically showing an operation of an information processing apparatus according to a second example embodiment. FIGS. 10A-10D are transition diagrams schematically showing the operation of the information processing apparatus according to the second example embodiment in the case of a suspicious mail.

First, the information acquisition part 31 of the phishing site detection part 30 of the information processing apparatus 10 acquires the suspicious site information 1 being browsed by the browsing processing part 20 (step B1).

Next, the element extraction part 32 of the phishing site detection part 30 extracts specified element(s) (here, the URL of the link destination, relative path(s), and other character strings in the suspicious site information 1) from the suspicious site information 1 acquired by the information acquisition part 31 (step B2).

Next, the element completion part 35 of the phishing site detection part 30 determines whether or not the specified element(s) extracted by the element extraction part 32 has the relative path(s) (step B3). When there is no relative path (NO in step B3), the process proceeds to step B5.

When there is the relative path(s) (YES in step B3), the element completion part 35 complements the relative path(s) so that it becomes a URL (step B4).

After step B4 or when there is no relative path (NO in step B3), the element similarity determination part 36 of the phishing site detection part 30 searches for a URL in the specified element(s) acquired from the element completion part 35, and when a URL is found, extracts the scheme (http://), host (www), top level domain (com, jp, etc.), second level domain (co, ac, go, etc.) representing the organizational attribute when there is an organizational attribute, and the specified domain excluding the directory (for example, a third level domain, a second level domain that does not represent an organizational attribute, etc.) from the URL (the URL of the linked destination in the suspicious site information 1) as specified element(s) (step B5). Note that when there is no URL in the specified element(s) acquired from the element completion part 35, step B5 is skipped.

Next, the element similarity determination part 36 calculates a similarity X of character strings between all (a part of them is acceptable) of the specified elements (step B6).

Next, the element similarity determination part 36 determines whether or not there is at least one similarity among the calculated similarities that is equal to or greater than the threshold value and less than 1 (step B7). When there is no similarity that is equal to or greater than the threshold value and less than 1 (NO in step B7), the process proceeds to step B10.

When there is at least one similarity that is equal to or greater than the threshold and less than 1 (YES in step B7), the element similarity determination part 36 determines that the site related to the suspicious site information 1 is highly likely to be the phishing site (step B8).

Next, the element similarity determination part 36 outputs a warning indicating that the site related to the suspicious site information 1 is highly likely to be the phishing site from the output part 13 (step B9), and then ends the process.

When there is no similarity that is equal to or greater than the threshold and less than 1 (NO in step B7), the element similarity determination part 36 determines that the site related to the suspicious site information 1 is not the phishing site (step B10), and then ends the process.

In the above mentioned second example embodiment, the target is suspicious site information 1 that is a suspicious phishing site, but the target can also be a suspicious mail that is a suspicious phishing mail (email), as shown in FIGS. 10A-10D. When a mail body such as that in FIG. 10A is displayed by the browsing processing part 20, the information acquisition part 31 acquires a mail source such as that in FIG. 10B, the element extraction part 32 extracts a specified element(s) as shown in FIG. 10C, and since there is no relative path in the extracted specified element(s), the processing in the element completion part 35 is skipped, and the element similarity determination part 36 can perform a similarity determination between the specified element(s) as shown in FIG. 10D.

Further, the second example embodiment can be used in combination with the first example embodiment, thereby improving the accuracy of detection phishing sites.

According to the second example embodiment, whether or not a site related to the suspicious site information 1 is the phishing site is determined based on the similarity of character strings between all or any of the specified element(s) extracted from the suspicious site information 1, thereby contributing to efficiently finding phishing sites without having to prepare information related to legitimate sites in advance.

### Example Embodiment 3

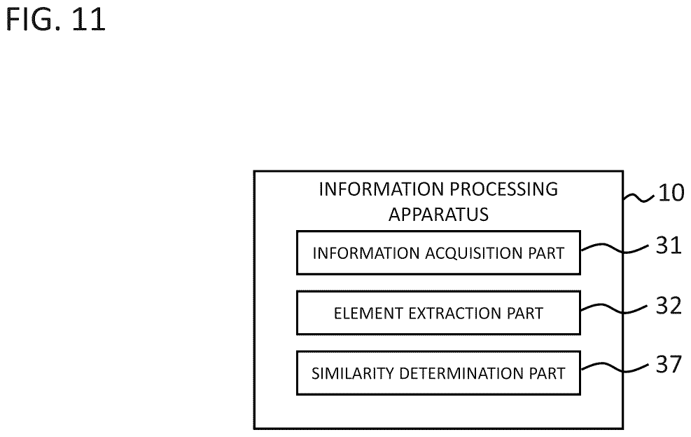

A description will be made with reference to the drawings regarding an information processing apparatus according to an example embodiment 3. FIG. 11 is a block diagram showing a schematic configuration of an information processing apparatus according to a third example embodiment.

The information processing apparatus 10 is an apparatus for processing information. The information processing apparatus 10 includes an information acquisition part 31, an element extraction part 32, and a similarity determination part 37. The information acquisition part 31 is configured to acquire suspicious site information. The element extraction part 32 is configured to extract a specified element(s) in the suspicious site information. The similarity determination part 37 is configured to calculate the similarity of character strings between a specified domain of a URL in a specified element(s) and a specified domain of a URL in the suspicious site information, or the similarity of character strings between all or any of the specified element(s). The similarity determination part 37 is configured to determine whether or not a site related to the suspicious site information is the phishing site depending on whether or not the similarity is within a predetermined numerical range.

According to an example embodiment 3, whether or not a site related to suspicious site information is the phishing site is determined based on the similarity of character strings between a specified domain of a URL in a specified element(s) and a specified domain of a URL in the suspicious site information, or the similarity of character strings between all or any of the specified element(s), thereby contributing to the efficient finding of phishing sites without the need to prepare information related to legitimate sites in advance.

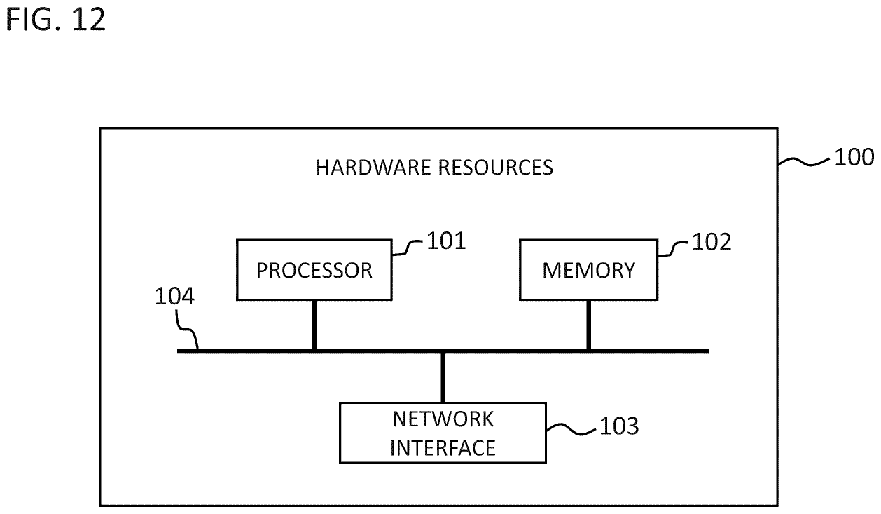

The information processing apparatus according to the first to third example embodiments can be configured with so called hardware resources (information processing apparatus, computers), and may use those having a configuration shown in FIG. 12. For example, the hardware resources 100 include a processor 101, a memory 102, a network interface 103, etc., which are connected to each other by an internal bus 104.

Note that the configuration shown in FIG. 12 is not intended to limit the hardware configuration of the hardware resources 100. The hardware resources 100 may include any hardware (for example, an input/output interface) that is not shown in the drawing. Alternatively, the number of parts such as the processor 101 included in the apparatus is not intended to be limited to the example shown in FIG. 12, and for example, multiple processors 101 may be included in the hardware resources 100. For example, a CPU (Central Processing Unit), an MPU (Micro Processor Unit), a GPU (Graphics Processing Unit), etc. may be used as the processor 101.

The memory 102 may be, for example, a random access memory (RAM), a read only memory (ROM), a hard disk drive (HDD), and/or a solid state drive (SSD), etc.

The network interface 103 may be, for example, a LAN (Local Area Network) card, a network adapter, a network interface card, etc.

The functions of the hardware resources 100 are realized by the above mentioned processing module. The processing module is realized, for example, by the processor 101 executing a program(s) stored in the memory 102. The program(s) can be updated by downloading it via a network or by using a storage medium on which the program(s) is stored. Furthermore, the processing module may be realized by a semiconductor chip. That is, it is sufficient that the functions performed by the processing module are realized by executing software on some kind of hardware.

A part or all of the above described example embodiments may be described as, but is not limited to, the following supplementary notes.

[Note 1] An information processing apparatus, comprising:
an information acquisition part configured to acquire suspicious site information;
an element extraction part configured to extract a specified element(s) from the suspicious site information; and
a similarity determination part configured to calculate a similarity of character string between a specified domain of a URL in the specified element(s) and a specified domain of a URL of the suspicious site information, or a similarity of between all or any of the specified element(s) to determine whether or not a site related to the suspicious site information is a phishing site based on whether or not the similarity is within a predetermined numerical range.
   [Note 2] The information processing apparatus according to note 1, wherein the specified element(s) is a link element(s), and
the similarity determination part is configured to calculate the similarity of character string between the specified domain of the URL in the specified element(s) and the specified domain of the URL in the suspicious site information to determine whether or not the site related to the suspicious site information is the phishing site, and wherein the similarity determination part comprises:
an element determination part configured to determine whether or not the URL exists in the specified element(s); and
a domain similarity determination part configured to calculate, when the URL exists in the specified element(s), the similarity of character strings between the specified domain of the URL in the specified element(s) and the specified domain of the URL in the suspicious site information, to determine whether or not the site related to the suspicious site information is the phishing site depending on whether or not the similarity is within the predetermined numerical range.
   [Note 3] The information processing apparatus according to note 2, wherein the element determination part is configured to determine that the site related to the suspicious site information is not the phishing site when the URL does not exist in the specified element(s), or when the element extraction part does not extract the specified element(s).
   [Note 4] The information processing apparatus according to note 2 or 3, wherein the domain similarity determination part is configured to extract the specified domain of the URL in the specified element(s) and to extract the specified domain of the URL of the suspicious site information.
   [Note 5] The information processing apparatus according to any one of notes 2 to 4, further comprising an output part, wherein the domain similarity determination part is configured to determine that the site related to the suspicious site information is highly likely to be the phishing site when the similarity is within the predetermined numerical range, to output a warning indicating that the site related to the suspicious site information is highly likely to be the phishing site from the output part.
   [Note 6] The information processing apparatus according to any one of notes 2 to 5, wherein the domain similarity determination part is configured to determine that the site related to the suspicious site information is not the phishing site when the similarity is not within the predetermined numerical range.
   [Note 7] The information processing apparatus according to note 1, wherein
the specified element(s) is any of link element(s), relative path(s) and character string(s), and
the similarity determination part is configured to calculate the similarity between character string(s) and all or any of the specified elements to determine whether or not the site related to the suspicious site information is the phishing site based on whether or not the similarity is within the predetermined numerical range, and wherein the similarity determination part comprises:
an element completion part configured to complete a relative path(s) when the specified element(s) has the relative path(s) so that the relative path(s) becomes the URL; and
an element similarity determination part configured to calculate the similarity of character strings between all or any of the predetermined elements after the completion to determine whether or not the site related to the suspicious site information is the phishing site depending on whether or not the similarity is within the predetermined numerical range.
   [Note 8] The information processing apparatus according to note 7, wherein the element similarity determination part is configured to extract the specified domain of the URL in the specified element(s).
   [Note 9] The information processing apparatus according to note 7 or 8, further comprising an output part, wherein the element similarity determination part is configured to determine that the site related to the suspicious site information is highly likely to be the phishing site when the similarity is within the predetermined numerical range, and to output a warning indicating that the site related to the suspicious site information is highly likely to be the phishing site from the output part.
   [Note 10] The information processing apparatus according to any one of notes 7 to 9, wherein the element similarity determination part is configured to determine that the site related to the suspicious site information is not the phishing site when the similarity is not within the predetermined numerical range.
   [Note 11]A phishing site detection method that detects a phishing site using hardware resources, comprising steps of:
acquiring suspicious site information;
extracting specified element(s) from the suspicious site information; calculating a similarity of character strings between a specified domain of a URL in the specified element(s) and a specified domain of a URL of the suspicious site information, or a similarity of character strings between all or any of the specified elements; and
determining whether or not the site related to the suspicious site information is the phishing site based on whether or not the similarity is within a predetermined numerical range.
   [Note 12]A program causing hardware resources to execute process of detecting a phishing site, comprising processes of:
acquiring suspicious site information; extracting specified element(s) from the suspicious site information;
calculating a similarity of character strings between a specified domain of a URL in the specified element(s) and a specified domain of a URL of the suspicious site information, or a similarity of character strings between all or any of the specified element(s); and
determining whether or not the site related to the suspicious site information is the phishing site based on whether or not the similarity is within a predetermined numerical range.

Note that the disclosures of the above patent documents and non-patent documents are incorporated herein by reference and may be used as the basis or part of the present invention as necessary. Within the framework of the entire disclosure of the present invention (including the claims and drawings), and further based on the basic technical idea, the example embodiments and examples can be modified and adjusted. Further, within the framework of the entire disclosure of the present invention, various combinations or selections (or non selection as necessary) of various disclosed element(s) (including each element of each claim, each element of each example embodiment or example, each element of each drawing, etc.) are possible. That is, the present invention naturally includes various modifications and corrections that a person skilled in the art would be able to make according to the entire disclosure, including the claims and drawings, and the technical idea. Furthermore, with regard to the numerical values and numerical ranges described in this application, any intermediate value, lower numerical value, and small range are considered to be described even if not explicitly recited. Furthermore, the disclosures of the above cited documents, if necessary, in accordance with the spirit of the present invention, may be used in part or in whole in combination with the description of this document as part of the disclosure of the present invention, and are considered to be included (belong) in the disclosures of this application.

### REFERENCE SIGNS LIST

1. Suspicious Site Information
10. Information Processing Apparatus
11. Communication Part
12. Input Part
13. Output Part
14. Memory Part
15. Control Part
20. Browsing Processing Part
30. Phishing Site Detection Part
31. Information Acquisition Part
32. Element Extraction Part
33. Element Determination Part
34. Domain Similarity Determination Part
35. Element Completion Part
36. Element Similarity Determination Part
37. Similarity Determination Part
40. Login Screen
41. New Registration Button
42. Mail Address Input Field
43. Password Input Field
44. Login Button
45. Forgot Password Button
46. Terms of Use/Privacy Policy Button
100. Hardware Resources
101. Processor
102. Memory
103. Network Interface
104. Internal Bus

What is claimed is:

1. An information processing apparatus, comprising:
at least one processor;
a memory in circuit communication with the processor;
wherein the processor is configured to execute program instructions stored in the memory to implement:
an information acquisition part configured to acquire suspicious site information;
an element extraction part configured to extract a specified element(s) from the suspicious site information; and
a similarity determination part configured to calculate a similarity of character string between a specified domain of a URL in the specified element(s) and a specified domain of a URL of the suspicious site information, or a similarity of between all or any of the specified element(s) to determine whether or not a site related to the suspicious site information is a phishing site based on whether or not the similarity is within a predetermined numerical range.

2. The information processing apparatus according to claim 1, wherein
the specified element(s) is a link element(s), and
the similarity determination part is configured to calculate the similarity of character string between the specified domain of the URL in the specified element(s) and the specified domain of the URL in the suspicious site information to determine whether or not the site related to the suspicious site information is the phishing site, and wherein
the similarity determination part comprises:
an element determination part configured to determine whether or not the URL exists in the specified element(s); and
a domain similarity determination part configured to calculate, when the URL exists in the specified element(s), the similarity of character strings between the specified domain of the URL in the specified element(s) and the specified domain of the URL in the suspicious site information, to determine whether or not the site related to the suspicious site information is the phishing site depending on whether or not the similarity is within the predetermined numerical range.

3. The information processing apparatus according to claim 2, wherein
the element determination part is configured to determine that the site related to the suspicious site information is not the phishing site when the URL does not exist in the specified element(s), or when the element extraction part does not extract the specified element(s).

4. The information processing apparatus according to claim 2, wherein
the domain similarity determination part is configured to extract the specified domain of the URL in the specified element(s) and to extract the specified domain of the URL of the suspicious site information.

5. The information processing apparatus according to claim 2, further comprising an output part, wherein
the domain similarity determination part is configured to determine that the site related to the suspicious site information is highly likely to be the phishing site when the similarity is within the predetermined numerical range, to output a warning indicating that the site related to the suspicious site information is highly likely to be the phishing site from the output part.

6. The information processing apparatus according to claim 2, wherein
the domain similarity determination part is configured to determine that the site related to the suspicious site information is not the phishing site when the similarity is not within the predetermined numerical range.

7. The information processing apparatus according to claim 1, wherein the specified element(s) is any of link element(s), relative path(s) and character string(s), and
the similarity determination part is configured to calculate the similarity between character string(s) and all or any of the specified elements to determine whether or not the site related to the suspicious site information is the phishing site based on whether or not the similarity is within the predetermined numerical range, and wherein
the similarity determination part comprises:
an element completion part configured to complete a relative path(s) when the specified element(s) has the relative path(s) so that the relative path(s) becomes the URL; and
an element similarity determination part configured to calculate the similarity of character strings between all or any of the predetermined elements after the completion to determine whether or not the site related to the suspicious site information is the phishing site depending on whether or not the similarity is within the predetermined numerical range.

8. The information processing apparatus according to claim 7, wherein
the element similarity determination part is configured to extract the specified domain of the URL in the specified element(s).

9. The information processing apparatus according to claim 7, further comprising an output part, wherein
the element similarity determination part is configured to determine that the site related to the suspicious site information is highly likely to be the phishing site when the similarity is within the predetermined numerical range, and to output a warning indicating that the site related to the suspicious site information is highly likely to be the phishing site from the output part.

10. The information processing apparatus according to claim 7, wherein
the element similarity determination part is configured to determine that the site related to the suspicious site information is not the phishing site when the similarity is not within the predetermined numerical range.

11. A phishing site detection method that detects a phishing site using hardware resources, comprising:
acquiring suspicious site information;
extracting specified element(s) from the suspicious site information;
calculating a similarity of character strings between a specified domain of a URL in the specified element(s) and a specified domain of a URL of the suspicious site information, or a similarity of character strings between all or any of the specified elements; and
determining whether or not the site related to the suspicious site information is the phishing site based on whether or not the similarity is within a predetermined numerical range.

12. A non-transitory computer readable storage medium storing a program causing hardware resources to execute process of detecting a phishing site, wherein the program causes the hardware resources to execute acquiring suspicious site information;
extracting specified element(s) from the suspicious site information;
calculating a similarity of character strings between a specified domain of a URL in the specified element(s) and a specified domain of a URL of the suspicious site information, or a similarity of character strings between all or any of the specified element(s); and
determining whether or not the site related to the suspicious site information is the phishing site based on whether or not the similarity is within a predetermined numerical range.

13. The phishing site detection method according to claim 11, wherein
the specified element(s) is any of link element(s), relative path(s) and character string(s), and
the similarity of character string(s) between the specified domain of the URL in the specified element(s) and the specified domain of the URL in the suspicious site information to determine whether or not the site related to the suspicious site information is the phishing site, and wherein,
for determining whether or not the site related to the suspicious site information is the phishing site, the method further comprises:
determining whether or not the URL exists in the specified element(s); and
calculating, when the URL exists in the specified element(s), the similarity of character strings between the specified domain of the URL in the specified element(s) and the specified domain of the URL in the suspicious site information, to determine whether or not the site related to the suspicious site information is the phishing site depending on whether or not the similarity is within the predetermined numerical range.

14. The phishing site detection method according to claim 11, wherein
the specified element(s) is any of link element(s), relative path(s), and character string(s), and
the similarity between character string(s) and all or any of the specified elements is calculated to determine whether or not the site related to the suspicious site information is the phishing site based on whether or not the similarity is within the predetermined numerical range, and wherein,
for determining whether or not the site related to the suspicious site information is the phishing site, the method further comprises:
completing a relative path(s) when the specified element(s) has the relative path(s) so that the relative path(s) becomes the URL; and
calculating the similarity of character strings between all or any of the predetermined elements after the completion to determine whether or not the site related to the suspicious site information is the phishing site depending on whether or not the similarity is within the predetermined numerical range.

15. The phishing site detection method according to claim 14, wherein,
for determining whether or not the site related to the suspicious site information is the phishing site, the method further comprises:
determining that the site related to the suspicious site information is highly likely to be the phishing site when the similarity is within the predetermined numerical range, and to output a warning indicating that the site related to the suspicious site information is highly likely to be the phishing site.

16. The phishing site detection method according to claim 15, wherein,
for determining whether or not the site related to the suspicious site information is the phishing site, the method further comprises:
determining that the site related to the suspicious site information is not the phishing site when the similarity is not within the predetermined numerical range.

17. The non-transitory computer readable storage medium according to claim 12, wherein
the specified element(s) is any of link element(s), relative path(s) and character string(s), and
the similarity between character string(s) and all or any of the specified elements is calculated to determine whether or not the site related to the suspicious site information is the phishing site based on whether or not the similarity is within the predetermined numerical range, and wherein,
for determining whether or not the site related to the suspicious site information is the phishing site, the program causes the hardware resources further to execute:
determining whether or not the URL exists in the specified element(s); and
calculating, when the URL exists in the specified element(s), the similarity of character strings between the specified domain of the URL in the specified element(s) and the specified domain of the URL in the suspicious site information, to determine whether or not the site related to the suspicious site information is the phishing site depending on whether or not the similarity is within the predetermined numerical range.

18. The non-transitory computer readable storage medium according to claim 12, wherein
the specified element(s) is any of link element(s), relative path(s), and character string(s), and
the similarity between character string(s) and all or any of the specified elements is calculated to determine whether or not the site related to the suspicious site information is the phishing site based on whether or not the similarity is within the predetermined numerical range, and wherein,
for determining whether or not the site related to the suspicious site information is the phishing site, the program causes the hardware resources further to execute:
completing a relative path(s) when the specified element(s) has the relative path(s) so that the relative path(s) becomes the URL; and
calculating the similarity of character strings between all or any of the predetermined elements after the completion to determine whether or not the site related to the suspicious site information is the phishing site depending on whether or not the similarity is within the predetermined numerical range.

19. The non-transitory computer readable storage medium according to claim 18, wherein,
for determining whether or not the site related to the suspicious site information is the phishing site, the program causes the hardware resources further to execute:
determining that the site related to the suspicious site information is highly likely to be the phishing site when the similarity is within the predetermined numerical range, and to output a warning indicating that the site related to the suspicious site information is highly likely to be the phishing site.

20. The non-transitory computer readable storage medium according to claim 19, wherein,
for determining whether or not the site related to the suspicious site information is the phishing site, the program causes the hardware resources further to execute:
determining that the site related to the suspicious site information is not the phishing site when the similarity is not within the predetermined numerical range.
